(19) United States
(12) Patent Application Publication
(10) Pub. No.: US 2015/0294518 A1
(43) Pub. Date: Oct. 15, 2015

(54) REMOTELY PROGRAMMED KEYLESS VEHICLE ENTRY SYSTEM

(71) Applicant: Ford Global Technologies, LLC, Dearborn, MI (US)

(72) Inventors: Christopher Peplin, Ann Arbor, MI (US); Jeff Allen Greenberg, Ann Arbor, MI (US); John Shutko, Ann Arbor, MI (US)

(73) Assignee: Ford Global Technologies, LLC, Dearborn, MI (US)

(21) Appl. No.: 14/249,447

(22) Filed: Apr. 10, 2014

(51) Int. Cl. G07C 9/00

(52) U.S. Cl. CPC G07C 9/00817; G07C 9/00142; G07C 9/00896; G07C 2009/00825

(57) ABSTRACT

A vehicle system includes a memory device, a communication interface, and a processing device. The memory device stores a primary keyless entry code associated with a vehicle. The communication interface receives an update command to change the primary keyless entry code to an updated keyless entry code. The processing device stores the updated keyless entry code in the memory device. When an authorized person provides the updated keyless entry code to the vehicle via, e.g., a keypad, the authorized person may gain access to the vehicle.

### BACKGROUND

Keyless entry systems allow vehicle owners to gain access to the vehicle if the owner is without his or her key. Typically, keyless entry systems provide a keypad on the door of the vehicle, and one or more doors will unlock with entry of a key code. A key is still required to drive the vehicle, but the key code will provide access to the passenger compartment, which in turn may allow the owner to open the hood or trunk of the vehicle. The key code cannot be changed by the vehicle owner without involving a technician. Thus, it is generally expected that the vehicle owner will not share the key code with others.

### BRIEF DESCRIPTION OF THE DRAWINGS

FIG. 1 illustrates an exemplary vehicle having a remotely programmed keyless entry system.

FIG. 2 illustrates an exemplary keypad that may be used in the vehicle of FIG. 1.

FIG. 3 is a block diagram of an exemplary keyless entry system that may be incorporated into the vehicle of FIG. 1.

FIG. 4 is a flowchart of an exemplary process that may be used to remotely program the keyless entry system.

### DETAILED DESCRIPTION

An exemplary vehicle system includes a memory device, a communication interface, and a processing device. The memory device stores a primary keyless entry code associated with a vehicle. The communication interface receives an update command to change the primary keyless entry code to an updated keyless entry code. The processing device stores the updated keyless entry code in the memory device.

When an authorized person provides the updated keyless entry code to the vehicle via, e.g., a keypad, the authorized person may gain access to the vehicle. Thus, the keyless entry code may be periodically updated to allow someone other than the vehicle owner (i.e., the authorized person) to temporarily operate the vehicle. The vehicle owner may leave the keys in the vehicle and give the authorized person the temporary keyless entry code, allowing the authorized person to access the passenger compartment to get the keys and operate the vehicle. Accordingly, the system may be used to give employees access to an employer-owned vehicle or customers of a rental car service access to a rental vehicle. Moreover, the system may permit vehicle owners to rent or lend their personal vehicles to others.

The vehicle and system shown in the FIGS. may take many different forms and include multiple and/or alternate components and facilities. The exemplary components illustrated are not intended to be limiting. Indeed, additional or alternative components and/or implementations may be used.

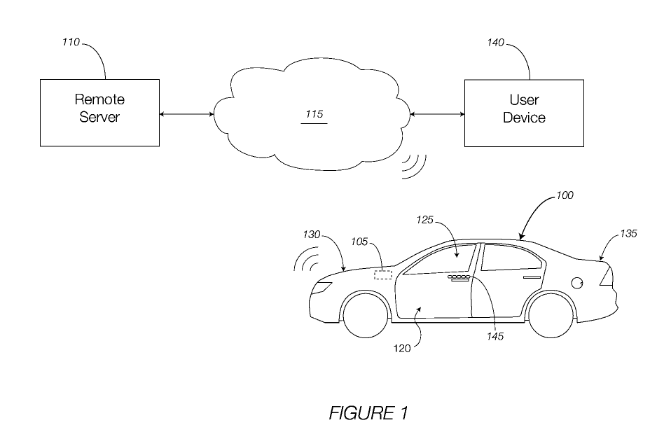

As illustrated in FIG. 1, a vehicle 100 includes a keyless entry system 105 that can be remotely programmed in accordance with commands received from a remote server 110 over a communication network 115. The vehicle 100 includes multiple doors 120 that can be unlocked and opened to provide access to a passenger compartment 125. Moreover, the vehicle 100 includes a hood 130 and a trunk 135. Opening the hood 130 may allow access to various components of the vehicle 100 such as the engine, coolant system, etc. Opening the trunk 135 may provide access to a cargo area. Although illustrated as a sedan, the vehicle 100 may include any passenger or commercial vehicle such as a car, a truck, a sport utility vehicle, a taxi, a bus, etc. In some possible approaches, as discussed below, the vehicle 100 is an autonomous vehicle configured to operate in an autonomous (e.g., driverless) mode, a partially autonomous mode, and/or a non-autonomous mode.

The remote server 110 may be configured to store and/or transmit information pertaining to the vehicle 100. Examples of such information may include software, software updates, and/or firmware associated with one or more components of the vehicle 100 including the engine controller, the body controller, the transmission controller, the autonomous mode controller, the navigation system, the entertainment system, the climate control system, the keyless entry system 105, or the like. For example, the remote server 110 may be configured to send commands such as an update command to update a primary keyless entry code to an updated keyless entry code, and in some circumstances, a revoke command to delete the updated keyless entry code. In some implementations, the updated keyless entry code may be transmitted by the remote server 110 with or after sending the update command. The remote server 110 may be configured to transmit and/or receive data over a communication network 115 in accordance with any number of communication protocols.

The remote server 110 may be configured to generate commands in accordance with a user input provided to, e.g., a user device 140. The user device 140 may include a computing device such as a cellular phone, a desktop computer, a laptop computer, a tablet computer, or the like. The user device 140 may be configured to communicate over any number of communication networks 115 and in accordance with any number of communication protocols. For purposes of simplicity, the remote server 110 is shown communicating with the vehicle 100 and the user device 140 over the same communication network 115. In some possible approaches, however, the remote server 110 may communicate with the user device 140 and vehicle 100 over different communication networks 115.

For instance, the user device 140 may receive a user input indicating the user's desire to change the primary keyless entry code. The user input may be provided via, e.g., a web browser or application running on the user device 140. The user device 140 may communicate with the remote server 110 over the communication network 115 to change the primary keyless entry code or generate a new keyless entry code (referred to as the “updated keyless entry code”). In one possible approach, the updated keyless entry code may be provided by the user. Alternatively, the updated keyless entry code may be automatically, and in some cases randomly, generated by the user device 140 or the remote server 110. The remote server 110 may communicate the updated keyless entry code to the vehicle 100. Whoever provides the updated keyless entry code (referred to below as “the authorized person”) to the keyless entry system 105 will be able to, e.g., open the doors 120 of the vehicle 100.

The user input may associate various restrictions with the updated keyless entry code. Examples of restrictions may include access restrictions and timing restrictions. Access restrictions may limit access to particular areas of the vehicle 100 or may limit the use of the vehicle 100 to particular modes of operation. For example, one access restriction may allow the authorized person to access the passenger compartment 125 but will not permit the authorized person to open the hood 130 from within the passenger compartment 125. Another access restriction may prevent the authorized person from opening the trunk 135 from within the passenger compartment 125. Other examples of access restrictions may include limiting the use of the vehicle 100 to “valet mode” where certain vehicle systems, such as the navigation system, are inaccessible to the authorized person. Timing restrictions may limit use of the vehicle 100 by the authorized person to particular times. For instance, the timing restrictions may permit the authorized person to access the vehicle 100 at particular times, for a particular length of time, or both. In some possible approaches, any number of access restrictions, timing restrictions, or both, may be associated with a particular updated keyless entry code.

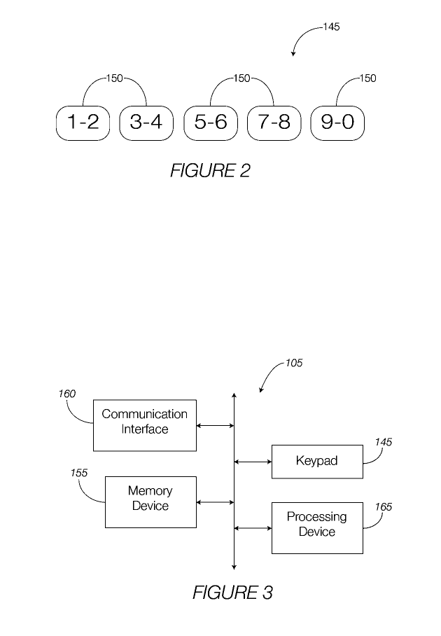

With reference now to FIG. 2, an exemplary keypad 145 is shown. The keypad 145 is illustrated as a numeric keypad 145 although the keypad 145 may include any alphanumeric or non-alphanumeric symbols. The keypad 145 may include any number of buttons 150, each associated with at least one symbol, configured to output a signal when manually pressed. The keyless entry code may be entered by pressing the correct combination of buttons 150 in the correct order.

FIG. 3 is a block diagram showing components of an exemplary keyless entry system 105. The keyless entry system 105, as illustrated, includes a keypad 145, such as the keypad 145 of FIG. 2, a memory device 155, a communication interface 160, and a processing device 165.

The memory device 155 may include any number of non-volatile memory devices configured to store data and make the stored data accessible to one or more systems and components of the vehicle 100. In one possible approach, the memory device 155 may be configured to store a primary keyless entry code, an updated keyless entry code, or the like.

The communication interface 160 may be configured to facilitate wired and/or wireless communication between the components of the vehicle 100 and other devices, such as the remote server 110, a key fob, or even another vehicle when using, e.g., a vehicle-to-vehicle communication protocol. The communication interface 160 may be configured to receive messages from, and transmit messages to, a cellular provider's tower and the Telematics Service Delivery Network (SDN) associated with the vehicle 100 that, in turn, establishes communication with a user's mobile device such as a cell phone, a tablet computer, a laptop computer, a fob, or any other electronic device configured for wireless communication via a secondary or the same cellular provider. Cellular communication to the telematics transceiver through the SDN may also be initiated from an internet connected device such as a PC, Laptop, Notebook, or WiFi connected phone. The communication interface 160 may also be configured to communicate directly from the vehicle 100 to the user device 140 or any other device using any number of communication protocols such as Bluetooth®, Bluetooth® Low Energy, or WiFi. An example of a vehicle-to-vehicle communication protocol may include, e.g., the dedicated short range communication (DSRC) protocol. Accordingly, the communication interface 160 may be configured to receive messages from and/or transmit messages to the remote server 110 and/or other vehicles.

In one possible implementation, the communication interface 160 may be configured to receive commands from the remote server 110. One possible command may include an update command to update the primary keyless entry code stored in the memory device 155 to an updated keyless entry code. Both the current and updated keyless entry codes may be stored in the memory device 155 in response to the update command. Alternatively, the primary keyless entry code may be deleted and replaced with the updated keyless entry code in the memory device 155. Another possible command may include a revoke command. In response to the revoke command, the updated keyless entry code may be deleted from the memory device 155 and/or replaced by the primary keyless entry code or some other keyless entry code.

Further, the communication interface 160 may be configured to transmit the updated keyless entry code to, e.g., a designated mobile device or another computing device via a communication protocol such as the Short Message Service (SMS) protocol. The mobile device may be designated by the user via the user device 140, discussed above. In one possible implementation, the communication interface 160 may transmit the updated keyless entry code to the mobile device or other computing device. Alternatively, the remote server 110 may transmit the updated keyless entry code to the mobile device or other computer device.

The processing device 165 may be configured to execute the commands received from the remote server 110. For example, the processing device 165 may store the updated keyless entry code in the memory device 155 after the communication interface 160 receives the update command. As discussed above, the updated keyless entry code may be transmitted by the remote server 110 with or after the update command. The processing device 165 may receive the update command and the updated keyless entry code and store the updated keyless entry code in the memory device 155. The processing device 165 may store the updated keyless entry code with the primary keyless entry code in the memory device 155. In some instances, however, the processing device 165 may delete the primary keyless entry code from the memory device 155 after receiving the update command. The processing device 165 may be configured to provide access to the vehicle 100 in accordance with the operation of the keyless entry system 105, such as when a user enters the updated keyless entry code, or any other keyless entry code stored in the memory device 155, into the keypad 145. Upon receipt of the correct code, the processing device 165 may be configured to, e.g., unlock the doors 120 to allow the authorized person access to the vehicle 100, or at least the passenger compartment 125.

The updated keyless entry code may be set to expire after the predetermined amount of time. When the predetermined amount of time elapses, the processing device 165 may be configured to delete the updated keyless entry code from the memory device 155, and in some instances, replace the updated keyless entry code with a different keyless entry code such as the previous keyless entry code. The predetermined amount of time may be set by the remote server 110 and transmitted with the update command, the updated keyless entry code, the revoke command, or at any other time. Alternatively, the predetermined amount of time may be set by the user and transmitted to the remote server 110 via, e.g., the user device 140.

The processing device 165 may be further configured to delete the updated keyless entry code according to a revoke command transmitted by the remote server 110. In some possible approaches, the revoke command may be transmitted to the vehicle 100 over the communication network 115 in response to a user input provided via the user device 140. After receipt of the revoke command, the processing device 165 may delete the updated keyless entry code from the memory device 155, and in some instances, save a different keyless entry code, which may be the same as the previous keyless entry code, to the memory device 155.

Accordingly, the keyless entry system 105 may permit the owner of the vehicle 100 to generate temporary keyless entry codes, which may be transmitted to designated recipients. The recipient may sue the temporary keyless entry code to access the passenger compartment 125 of the vehicle 100 where the keys to start the vehicle 100 may be located. The recipient may be permitted to use the vehicle 100 until the revoke command is sent, the temporary keyless entry code expires, or the vehicle 100 is otherwise disabled to prevent further use by the recipient. Such a keyless entry system 105 may allow the owner to rent the vehicle 100 to others on a short-term basis. Alternatively or in addition, the keyless entry system 105 may allow employees to temporarily use work vehicles at designated times.

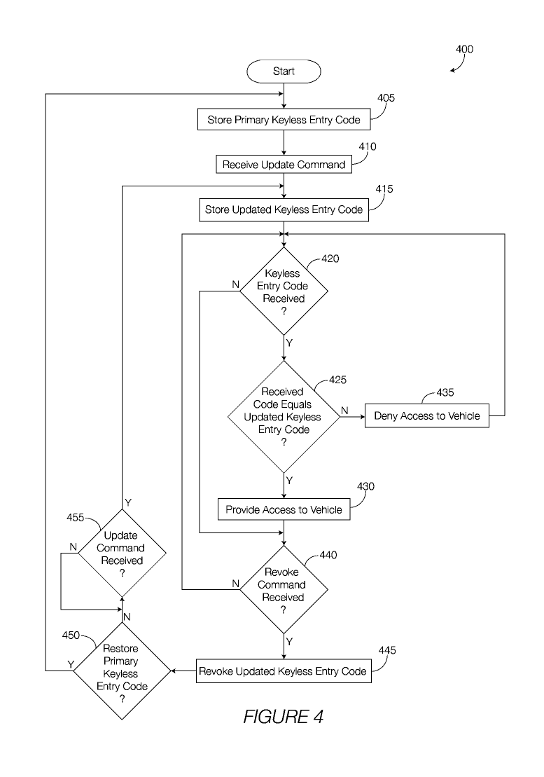

FIG. 4 is a flowchart of an exemplary process 400 that may be implemented by one or more components of the keyless entry system 105 of FIG. 3.

At block 405, the processing device 165 may store the primary keyless entry code in the memory device 155. The primary keyless entry code may already be stored in the memory device 155 at the time the vehicle 100 is purchased by the owner or may be set at any other time, such as in response to a revoke command received via the communication interface 160 and executed by the processing device 165.

At block 410, the processing device 165 may receive the update command. The update command may be transmitted from the remote server 110 over the communication network 115. The update command may be received at the vehicle 100 via the communication interface 160, which may pass the update command to the processing device 165 for processing. The update command may include the updated keyless entry code.

At block 415, the processing device 165 may store the updated keyless entry code in the memory device 155. In some instances, the processing device 165 may delete the primary keyless entry code either prior to or shortly after storing the updated keyless entry code in the memory device 155. This way, the memory device 155 may only contain one keyless entry code at any particular time. In some possible approaches, the memory device 155 may store any number of keyless entry codes, which may include both the primary keyless entry code and the updated keyless entry code.

At decision block 420, the processing device 165 may determine whether a keyless entry code has been entered into the keypad 145. If so, the process 400 may continue at block 425. If no keyless entry code has been received, the process 400 may continue at block 440.

At decision block 425, the processing device 165 may determine whether the keyless entry code received via the keypad 145 is the same as any of the keyless entry codes stored in the memory device 155. If so, the process 400 may continue at block 430. If the keyless entry code does not match any of those stored in the memory device 155, the process 400 may continue at block 435.

At block 430, the processing device 165 may provide access to the vehicle 100. Providing access to the vehicle 100 may include unlocking the doors 120 to allow access to the passenger compartment 125. The access to the vehicle 100 may be limited, however. For example, while the processing device 165 may cause the doors 120 to unlock, the processing device 165 may prevent the trunk 135 and/or hood 130 from being opened by someone who accessed the vehicle 100 by entering the keyless entry code into the keypad 145.

At block 435, the processing device 165 may deny access to the vehicle 100. Denying access to the vehicle 100 may include locking or keeping the doors 120 locked. In some possible approaches, denying access to the vehicle 100 may include sounding an alarm or providing a notification to the owner that someone has unsuccessfully attempted to access the vehicle 100 via the keypad 145. The notification may be provided via a wireless communication such as an SMS message to the owner's mobile device. The processing device 165 may sound the alarm and/or provide the notification after a predetermined number (e.g., three) of unsuccessful attempts to access the vehicle 100.

At block 440, the processing device 165 may determine whether the revoke command has been received. The revoke command may be transmitted by the remote server 110 and received at the vehicle 100 by the communication interface 160. The communication interface 160 may pass the revoke command to the processing device 165 for processing. If received, the process 400 may continue at block 445. If the revoke command has not been received, the process 400 may continue at block 420.

At block 445, the processing device 165 may revoke the updated keyless entry code. Revoking the updated keyless entry code may include deleting the keyless entry code from the memory device 155, meaning that entering the updated keyless entry code into the keypad 145 will not allow one to access the vehicle 100.

At block 450, the processing device 165 may determine whether to restore the primary keyless entry code. The primary keyless entry code may be restored if, e.g., it was deleted when the updated keyless entry code was stored in the memory device 155. If the primary keyless entry code is to be restored, the process 400 may continue at block 405. If not, the process 400 may continue at block 455.

At block 455, the processing device 165 may determine whether a subsequent update command has been received. As discussed above, the update command may be transmitted by the remote server 110, and in some instances may include another updated keyless entry code. If so, the process 400 may continue at block 415 so that the updated keyless entry code may be stored in the memory device 155. If no update command has been received, the process 400 may continue at block 455 until the update command has been received.

In general, computing systems and/or devices discussed above may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a memory device configured to store a primary keyless entry code associated with a vehicle;
a communication interface configured to receive an update command to change the primary keyless entry code to an updated keyless entry code; and
a processing device configured to store the updated keyless entry code in the memory device, wherein the updated keyless entry code provides access to the vehicle.

2. The vehicle system of claim 1, wherein the updated keyless entry code is determined from a user input.

3. The vehicle system of claim 1, wherein the update command is generated in response to a user input.

4. The vehicle system of claim 1, wherein the communication interface is configured to receive the update command from a remote server.

5. The vehicle system of claim 4, wherein the communication interface is configured to receive the updated keyless entry code from the remote server.

6. The vehicle system of claim 1, wherein the processing device is configured to revoke the updated keyless entry code in response to a revoke command.

7. The vehicle system of claim 6, wherein the processing device is configured to delete the updated keyless entry code from the memory device in response to the revoke command.

8. The vehicle system of claim 1, wherein the processing device is configured to delete the primary keyless entry code in response to the update command.

9. A vehicle comprising:
a keyless entry system having:
a keypad,
a memory device configured to store a primary keyless entry code,
a communication interface configured to receive an update command to change the primary keyless entry code to an updated keyless entry code, and
a processing device configured to store the updated keyless entry code in the memory device;
wherein the keyless entry system is configured to provide access to the vehicle in response to a user entering the updated keyless entry code via the keypad.

10. The vehicle of claim 9, wherein the updated keyless entry code is determined from a user input.

11. The vehicle of claim 9, wherein the update command is generated in response to a user input.

12. The vehicle of claim 9, wherein the communication interface is configured to receive the update command from a remote server.

13. The vehicle of claim 12, wherein the communication interface is configured to receive the updated keyless entry code from the remote server.

14. The vehicle of claim 9, wherein the processing device is configured to revoke the updated keyless entry code in response to a revoke command.

15. The vehicle of claim 14, wherein the processing device is configured to delete the updated keyless entry code from the memory device in response to the revoke command.

16. The vehicle of claim 9, wherein the processing device is configured to delete the primary keyless entry code in response to the update command.

17. A method comprising:
storing a primary keyless entry code in a vehicle memory device;
receiving, from a remote server, an update command to change the primary keyless entry code to an updated keyless entry code;
storing the updated keyless entry code in the memory device; and
providing access to a vehicle in response to a user entering the updated keyless entry code.

18. The method of claim 17, further comprising:
receiving a revoke command; and
revoking the updated keyless entry code in response to a revoke command.

19. The method of claim 18, wherein the processing device is configured to delete the updated keyless entry code from the memory device in response to the revoke command.

20. The method of claim 17, wherein storing the updated keyless entry code includes deleting the primary keyless entry code from the memory device.
